(19) United States
(12) Patent Application Publication
(10) Pub. No.: US 2025/0386804 A1
(43) Pub. Date: Dec. 25, 2025

(54) ANIMAL BEHAVIOR IMAGE PROCESSING SYSTEM AND METHOD

(71) Applicant: MyAnIML Inc., OVERLAND PARK, KS (US)

(72) Inventors: SHEKHAR GUPTA, OVERLAND PARK, KS (US); SAROJ GUPTA, OVERLAND PARK, KS (US)

(21) Appl. No.: 18/752,270

(22) Filed: Jun. 24, 2024

(51) Int. Cl. A01K 29/00; G06V 10/82; G06V 40/10

(52) U.S. Cl. CPC A01K 29/005; G06V 10/82; G06V 40/10

(57) ABSTRACT

A system includes a memory storing computer-readable instructions and at least one processor to execute the instructions to obtain images, by at least one image capture device, of animal behavior information associated with an animal, compare the animal behavior information with a machine learning model, each machine learning model related to a particular animal health condition, determine that the animal behavior information indicates a potential health condition for the animal, obtain animal identification information for the animal with the potential health condition, and transmit a notification indicating the animal identification information for the animal with the potential health condition.

### BACKGROUND

Animals such as cattle suffer from a variety of different diseases and ailments. As an example, Bovine Respiratory Disease Complex (BRDC) is a disease complex that includes shipping fever, pneumonia, diarrhea, and can be viral or bacterial. Bovine respiratory disease (BRD) has a significant economic impact on the U.S. cattle industry resulting in losses of $900 million to $1 billion annually. BRD accounts for 50% to 70% of all deaths in feedlot cattle, resulting in direct losses of animals. BRD decreases average daily gain in cattle, leading to longer days on feed and increases costs. BRD can negatively impact hot carcass weight, marbling scores, and overall carcass quality grades, reducing carcass value. According to research, cattle treated once, twice, or three or more times for BRD see net returns decrease by $38, $167, and $230 per calf respectively due to performance losses. The USDA estimates that 16% of cattle in large feedlots are affected by BRD, costing $23.60 per case on average. However, other research points to even higher costs. Hence, BRD remains the costliest disease impacting the U.S. cattle industry through significant treatment expenditures, mortality losses, reduced efficiencies, diminished carcass quality, and ultimately lower profitability for producers.

Additionally, a study estimated that 50% of milk-producing cows in the U.S. harbor mastitis-causing pathogens, with an average of two infected quarters per infected cow, leading to a 10% annual milk loss. Another estimate suggests the total cost of uncontrolled mastitis could reach $435 million per year or $23 per cow in the U.S. when factoring in loss of cows, milk, and therapy costs. Subclinical mastitis alone is estimated to cost the U.S. dairy industry over $1 billion annually.

It is with these issues in mind, among others, that various aspects of the disclosure were conceived.

### SUMMARY

The present disclosure is directed to an animal behavior image processing system and method. In one example, the system may include a plurality of image capture devices that may capture images of a plurality of animals, at least one client computing device, and at least one server computing device. The images may be processed by the client computing device and/or the server computing device and the client computing device and/or the server computing device may determine that an animal is suffering from a potential health condition and may send a notification to the client computing device and/or the server computing device. The notification may include information associated with the animal such as animal identification information or location information of the animal.

In one example, a system may include a memory storing computer-readable instructions and at least one processor to execute the instructions to obtain images, by at least one image capture device, of animal behavior information associated with an animal, compare the animal behavior information with a machine learning model, each machine learning model related to a particular animal health condition, determine that the animal behavior information indicates a potential health condition for the animal, obtain animal identification information for the animal with the potential health condition, and transmit a notification indicating the animal identification information for the animal with the potential health condition.

In another example, a method may include obtaining images, by at least one image capture device, of animal behavior information associated with an animal, comparing, by at least one processor, the animal behavior information with a machine learning model, each machine learning model related to a particular animal health condition, determining, by the at least one processor, that the animal behavior information indicates a potential health condition for the animal, obtaining, by the at least one processor, animal identification information for the animal with the potential health condition, and transmitting, by the at least one processor, a notification indicating the animal identification information for the animal with the potential health condition.

In another example, a non-transitory computer-readable storage medium includes instructions stored thereon that, when executed by a computing device cause the computing device to perform operations, the operations including obtaining images, by at least one image capture device, of animal behavior information associated with an animal, comparing the animal behavior information with a machine learning model, each machine learning model related to a particular animal health condition, determining that the animal behavior information indicates a potential health condition for the animal, obtaining animal identification information for the animal with the potential health condition, and transmitting a notification indicating the animal identification information for the animal with the potential health condition.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of an animal behavior image processing system according to an example of the instant disclosure.

FIG. 2 is a block diagram of a plurality of image capture devices capturing images of an animal according to an example of the instant disclosure.

FIG. 3 is a flowchart of a method of transmitting a notification indicating animal identification information for an animal with a potential health condition according to an example of the instant disclosure.

FIG. 4 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of an animal behavior image processing system includes a plurality of image capture devices that may capture images of a plurality of animals, at least one client computing device, and at least one server computing device. The images may be processed by the client computing device and/or the server computing device and the client computing device and/or the server computing device may determine that an animal is suffering from a potential health condition and may send a notification to the client computing device and/or the server computing device. The notification may include information associated with the animal such as animal identification information or location information of the animal, among other information.

As an example, a system may include a memory storing computer-readable instructions and at least one processor to execute the instructions to obtain images, by at least one image capture device, of animal behavior information associated with an animal, compare the animal behavior information with a machine learning model, each machine learning model related to a particular animal health condition, determine that the animal behavior information indicates a potential health condition for the animal, obtain animal identification information for the animal with the potential health condition, and transmit a notification indicating the animal identification information for the animal with the potential health condition.

As an example, the animal behavior image processing system may include a plurality of cameras such as security cameras or specialized hardware camera devices to obtain images and/or videos of cattle in a herd or obtain images or videos of individual animals.

As an example, the animal behavior image processing system may build a machine learning or artificial intelligence (AI) system having models that may correspond with a variety of potential health conditions to analyze cattle behavior from camera footage including a number of operations.

Data Collection: The animal behavior image processing system may capture a large dataset of video footage showing cattle exhibiting various behaviors, including head jerks due to cough or breathing issues. The animal behavior image processing system may use footage that is diverse, covering different angles, lighting conditions, and backgrounds. As an example, the images may be analyzed with the assistance of ranchers and veterinarians to determine if head jerks were voluntary or involuntary. As an example, if a head jerk is involuntary, ranchers or veterinarians may provide information associated with a potential or known cause of the head jerk and images in the dataset may be labeled.

Data Annotation: This may include manually annotating video footage by labeling frames where cattle exhibit head jerks due to cough or breathing issues. The labeled data may be used to train the Al or machine learning model.

Object Detection and Tracking: The Al system may detect and track the cattle's head in the video frames. This can be accomplished using object detection and tracking algorithms, such as YOLO (You Only Look Once) or Mask R-CNN, among others.

Feature Extraction: Once the cattle's head is detected and tracked, the animal behavior image processing system may extract relevant features from the video frames, such as head movement patterns, acceleration, and jerking motions. This can be done using computer vision techniques like optical flow analysis, motion vectors, and feature descriptors like SIFT or HOG.

Model Selection: The animal behavior image processing system may utilize an appropriate deep learning model architecture for video analysis, such as 3D Convolutional Neural Networks (3D CNNs) or Recurrent Neural Networks (RNNs) or YOLO or a combination of any of these. These models are designed to process temporal data such as videos.

Model Training: The animal behavior image processing system may split the annotated dataset into training and validation sets. The animal behavior image processing system may train the selected deep learning model on the training set, using techniques like transfer learning or data augmentation to improve performance.

Model Evaluation: The animal behavior image processing system may evaluate the trained model's performance on the validation set, measuring metrics like accuracy, precision, recall, and F1-score for detecting head jerks due to cough or breathing issues.

Model Optimization: If the model's performance is unsatisfactory, the animal behavior image processing system may use techniques such as hyperparameter tuning, architecture modifications, or additional data collection and annotation.

Integration: The animal behavior image processing system may be integrated with other cattle monitoring systems and may include a user interface to alert farmers or veterinarians when concerning behaviors are detected.

As another example, the animal behavior image processing system may be used to detect sunken eyes in dairy cows and could be implemented in a dairy parlor setting. As an example, cameras or image capture devices could be installed and/or located in a dairy parlor to capture images of the cows' faces as they enter for milking. Thus, this may allow monitoring of eye characteristics like sunken eyes.

The camera positioning and distance from the cows may be optimized for clear facial imaging, such as three to four meters. In addition, the camera positioning and distance may be modified for each dairy parlor. As an example, different camera angles may be utilized in each instance.

AI for Eye Analysis—The animal behavior image processing system may utilize machine vision and deep learning techniques like convolutional neural networks (CNNs) to train on datasets of cow facial images to detect and analyze eye features. As an example, the animal behavior image processing system may feed each healthy cow's face and eyes in the system to determine healthy eye features for each particular cow. As a result, the animal behavior image processing system may determine a change in eyes of an animal such as sunken eye. The system may detect such a change and send notifications.

The animal behavior image processing system may determine specific characteristics like increased visibility of the sclera, deepening of the eye sockets, darkening under the eyes, etc. could indicate sunken/hollowed eyes. The Al and/or machine learning models may learn visual patterns associated with normal vs. sunken eye appearances in cows. As a result, the animal behavior image processing system may perform automated detection of sunken eyes to assist in screening for conditions like dehydration, malnutrition, or diseases that may cause such a symptom in dairy cows or other animals.

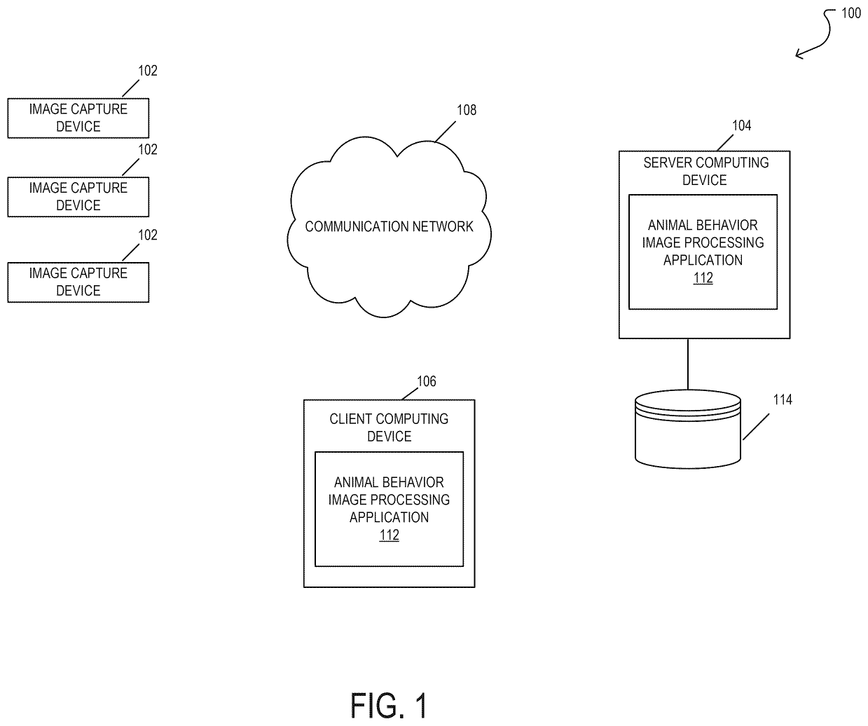

FIG. 1 is a block diagram of an animal behavior image processing system 100 according to an example of the instant disclosure. The system may include a plurality of image capture devices 102. Each image capture device 102 may capture images such as still images and video of an animal such as cattle including cows and bulls. However, the image capture devices 102 may capture images of livestock, domesticated animals, or wild animals. The system 100 may include at least one server computing device 104 and at least one client computing device 106. The at least one server computing device 104 may have or be in communication with at least one database 114.

The client computing device 106 and the server computing device 104 may have an animal behavior image processing application 112 that may be a component of an application and/or service executable by the at least one client computing device 106, and/or the server computing device 104. For example, the animal behavior image processing application 112 may be a single unit of deployable executable code or a plurality of units of deployable executable code. According to one aspect, the animal behavior image processing application 112 may include one component that may be a web application, a native application, and/or a mobile application (e.g., an app) downloaded from a digital distribution application platform that allows users to browse and download applications developed with mobile software development kits (SDKs) including the App Store and GOOGLE PLAY®, among others.

The animal behavior image processing system 100 also may include a relational database management system (RDBMS) or another type of database management system such as a NoSQL database system that stores and communicates data from at least one database 114. The data stored in the database 114 may be associated with the plurality of animals such as image information of the animals and a dataset of video footage showing animals such as cattle exhibiting behaviors including head jerks due to cough or breathing issues. In another example, the data stored in the database 114 may be a dataset associated with dairy cows' eyes and faces including images of dairy cows that are healthy.

The at least one image capture device 102, at least one client computing device 106, and the at least one server computing device 104 may be configured to receive data from and/or transmit data through a communication network 108. Although the image capture device 102, the client computing device 106, and the server computing device 104 are shown as a single computing device, it is contemplated each computing device may include multiple computing devices.

The communication network 108 can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a near field communication (NFC) network, a LoRaWAN network, a satellite communications network, or an IEEE 802.11 standards network, as well as various communications thereof. Other conventional and/or later developed wired and wireless networks may also be used.

The image capture device 102 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the image capture device 102 further includes at least one communications interface to transmit and receive communications, messages, and/or signals.

The client computing device 106 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the client computing device 106 further includes at least one communications interface to transmit and receive communications, messages, and/or signals.

The client computing device 106 could be a programmable logic controller, a programmable controller, a laptop computer, a smartphone, a personal digital assistant, a tablet computer, a standard personal computer, or another processing device. The client computing device 106 may include a display, such as a computer monitor, for displaying data and/or graphical user interfaces. The client computing device 106 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The server computing device 104 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the server computing device 104 further includes at least one communications interface to transmit and receive communications, messages, and/or signals.

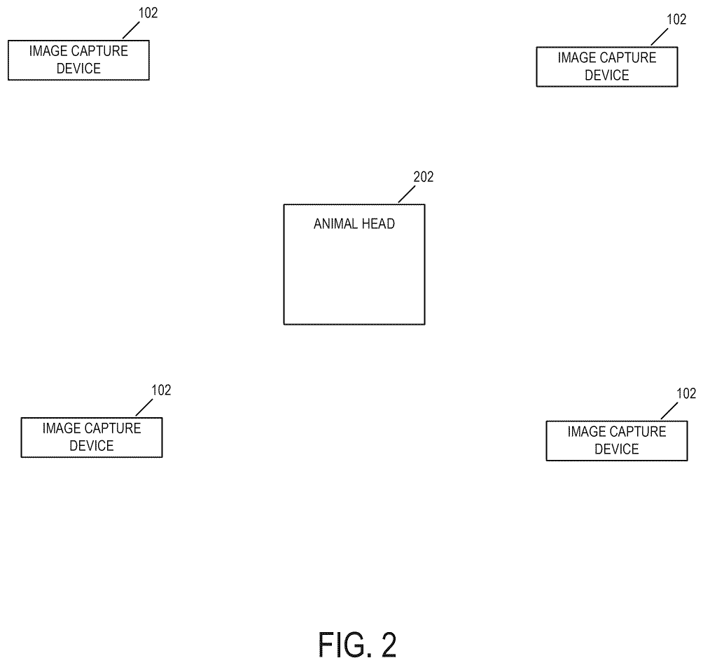

FIG. 2 is a block diagram of a plurality of image capture devices 102 capturing images of an animal 202 according to an example of the instant disclosure. In one example, the animal 202 may be a bovine such as cows or bulls in addition to other animals such as sheep, goat, pigs, etc. As shown in FIG. 2, there may be one or more image capture devices 102 that may be located in a location such as on a ranch or in a dairy pen.

The one or more image capture devices 102 may be installed in locations that may allow the one or more image capture devices 102 to obtain images including still images or video of animals including images of faces or eyes of the animals 202. In one example, the plurality of image capture devices 102 may communicate with one another and determine one or more of the image capture devices 102 that are able to capture the faces or eyes of the animals 202. As an example, at a first time, image capture device three and image capture device four may not be able to view faces or eyes of the animals 202 because the animals may not be facing the one or more image capture devices 102. However, at the first time, image capture device one and image capture device two may be able to view faces and eyes. Thus, image capture device one and image capture device two may capture images of the faces and eyes. However, at a second time after the first time, the animal 202 may move to a different position and the image capture device three and image capture device four may be able to capture images of the faces and eyes of the animal 202. The image capture devices 102 may automatically transition from one or more of the image capture devices to one or more of the image capture devices to obtain images of a head or face of the animal 202.

Additionally, in one example, the one or more image capture devices 102 may capture the images of the animal 202 that may include a face of the animal to identify a particular animal, e.g., Animal234. The one or more image capture devices 102 may transmit the images that may include still images and/or video of the animal 202 to the client computing device 106 and/or the server computing device 104. The client computing device 106 and/or the server computing device 104 may execute the animal behavior image processing application 112 to determine facial features of the animal 202 and muzzle features of the animal 202. In some examples, the animal behavior image processing application 112 may crop out muzzle information and features from the image.

As a result, the client computing device 106 and/or the server computing device 104 may determine a potential health condition about the animal 202 based on changes in the facial features and/or muzzle features of the animal 202. As an example, the client computing device 106 and/or the server computing device 104 may analyze changes in a first image of the animal 202 captured at a first time and a second image of the animal captured at a second time after the first time 202. In one example, the client computing device 106 and/or the server computing device 104 may compare the first image of the animal and the second image of the animal with a machine learning model, each machine learning model related to a particular animal health condition. As an example, the changes that are determined between the first image of the animal and the second image of the animal may indicate that the animal may be suffering from Bovine Respiratory Disease Complex (BRDC), among other issues.

If the comparison between the first image and the second image indicates a particular animal health condition, the animal behavior image processing application 112 may send a push notification, an alert, message, or another type of communication in realtime to an appropriate computing device such as a computing device that may be assigned to and located closest to the animal that may be ill. In one example, the alert may be message sent to a rancher before cattle become ill and spread disease by determining a location of a rancher computing device and sending the message to a rancher that may be located closest to the animal with the health condition. In one example, this may include determining a location of the animal that may be ill using a GPS hardware device that may be associated with the animal such as an eartag on the animal or otherwise attached to the animal and determining a location of the computing device using at least one of global positioning system (GPS) hardware, cellular triangulation, and Wi-Fi positioning, and sending the message to the computing device of the rancher.

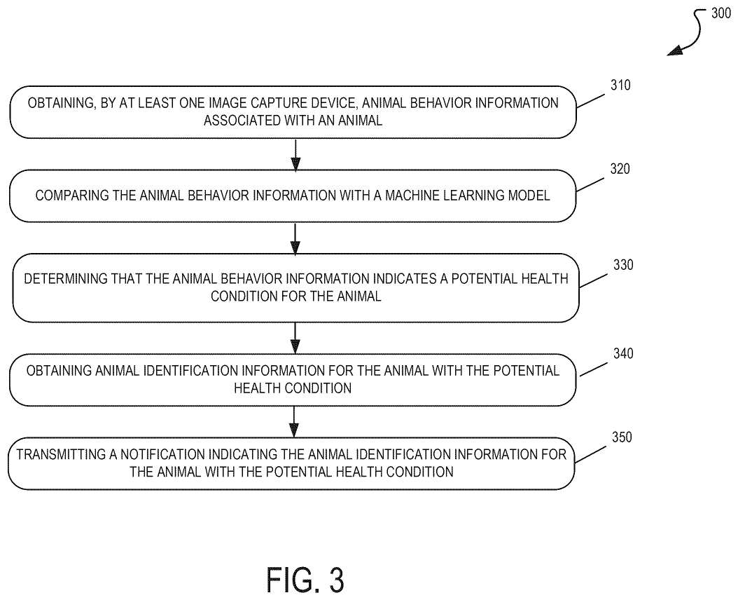

FIG. 3 illustrates an example method 300 of transmitting a notification indicating animal identification information for an animal with a potential health condition according to an example of the instant disclosure. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 may include obtaining images, by at least one image capture device 102, of animal behavior information associated with an animal 202 at block 310. As an example, the animal may be a bovine such as a cow or bull.

Next, according to some examples, the method 300 may include comparing the animal behavior information with a machine learning model, each machine learning model related to a particular animal health condition at block 320.

Next, according to some examples, the method 300 may include determining that the animal behavior information indicates a potential health condition for the animal 202 at block 330.

Next, according to some examples, the method 300 may include obtaining animal identification information for the animal 202 with the potential health condition at block 340. In one example, the animal identification information for the animal may be based on facial recognition of a particular animal that may be present on a ranch or in a dairy barn. As an example, the method 300 may include determining a particular location of the animal using a global positioning system (GPS) device and determining the animal identification information such as an identifier for the animal, e.g., ABCD1234, or a nickname or name of the animal, e.g., Cow One.

Next, according to some examples, the method 300 may include transmitting a notification indicating the animal identification information for the animal 202 with the potential health condition at block 350.

According to some examples, the method 300 may include training a machine learning model having a dataset with a plurality of images of animals having Bovine Respiratory Disease Complex (BRDC).

According to some examples, the method 300 may include detecting and tracking a head of the animal.

According to some examples, the method 300 may include extracting relevant features from the images, the relevant features including one of head movement patterns, acceleration of the head of the animal, and jerking motions of the head of the animal, among others.

According to some examples, the method 300 may include providing annotation of the images by labeling images where the animal exhibits head jerks associated with one of coughing and breathing issues. According to some examples, the method 300 may include training the model using the annotation.

According to some examples, the method 300 may include determining that the animal behavior information indicates a violent movement of a head of the animal representative of a cough.

According to some examples, the method 300 may include determining that the animal behavior information indicates a plurality of violent movements of a head of the animal representative of a number of coughs in a particular period of time.

According to some examples, the method 300 may include determining that the animal behavior information indicates a plurality of violent movements of a head of the animal representative of a number of coughs in a first particular period of time and determining that the animal behavior information indicates a plurality of violent movements of a head of the animal representative of a number of coughs in a second particular period of time and determining that the number of coughs in the first particular period of time is greater than the number of coughs in the second particular period of time. This may indicate a worsening of a health of the animal.

According to some examples, the method 300 may include determining that the animal behavior information indicates a plurality of violent movements of a head of the animal representative of a number of coughs in a first particular period of time and determining that the animal behavior information indicates a plurality of violent movements of a head of the animal representative of a number of coughs in a second particular period of time and determining that the number of coughs in the first particular period of time is less than the number of coughs in the second particular period of time. This may indicate an improvement of a health of the animal.

According to some examples, the method 300 may include training a machine learning model having a dataset with a plurality of images of animals having mastitis.

As an example, the dataset may include images of faces and eyes of healthy cows.

According to some examples, the method 300 may include comparing the images obtained by the at least one image capture device to the dataset of images of faces and eyes of healthy cows and determining a presence of at least one sunken eye in the animal.

According to some examples, the method 300 may include training the machine learning model to detect and analyze eye features of the animal.

According to some examples, the method 300 may include determining one of increased visibility of a sclera of the animal, deepening of eye sockets of the animal, and darkening under at least one eye of the animal.

According to some examples, the method 300 may include sending an image of the animal, the image representative of the potential health condition.

According to some examples, the method 300 may include sending a video of the animal, the video representative of the potential health condition.

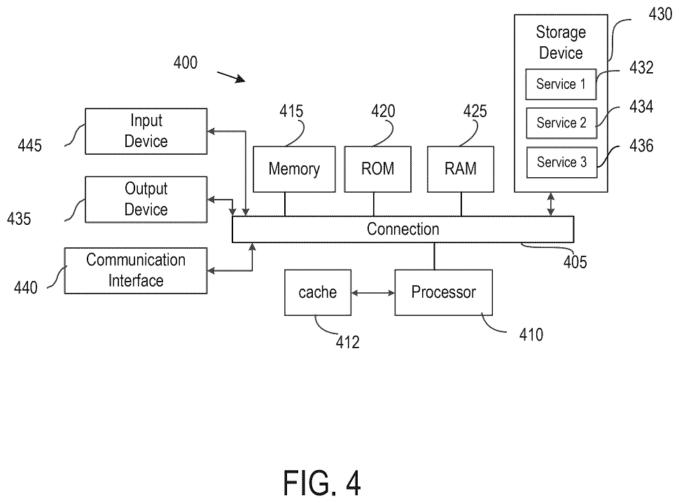

FIG. 4 shows an example of computing system 400, which can be for example any computing device making up the computing device such as the image capture device 102, the client computing device 106, the server computing device 104, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A system comprising: a memory storing computer-readable instructions and at least one processor to execute the instructions to obtain images, by at least one image capture device, of animal behavior information associated with an animal, compare the animal behavior information with a machine learning model, each machine learning model related to a particular animal health condition, determine that the animal behavior information indicates a potential health condition for the animal, obtain animal identification information for the animal with the potential health condition, and transmit a notification indicating the animal identification information for the animal with the potential health condition.

Aspect 2: The system of Aspect 1, the at least one processor further to execute the instructions to train a machine learning model having a dataset with a plurality of images of animals having Bovine Respiratory Disease Complex (BRDC).

Aspect 3: The system of Aspects 1 and 2, the at least one processor further to execute the instructions to detect and track a head of the animal.

Aspect 4: The system of Aspects 1 to 3, the at least one processor further to execute the instructions to extract relevant features from the images, the relevant features comprising one of head movement patterns, acceleration of the head of the animal, and jerking motions of the head of the animal.

Aspect 5: The system of Aspects 1 to 4, the at least one processor further to execute the instructions to provide annotation of the images by labeling images where the animal exhibits head jerks associated with one of coughing and breathing issues.

Aspect 6: The system of Aspects 1 to 5, the at least one processor further to train the model using the annotation.

Aspect 7: The system of Aspects 1 to 6, the at least one processor further to execute the instructions to determine that the animal behavior information indicates a violent movement of a head of the animal representative of a cough.

Aspect 8: The system of Aspects 1 to 7, the at least one processor further to execute the instructions to determine that the animal behavior information indicates a plurality of violent movements of a head of the animal representative of a number of coughs in a particular period of time.

Aspect 9: The system of Aspects 1 to 8, the at least one processor further to execute the instructions to determine that the animal behavior information indicates a plurality of violent movements of a head of the animal representative of a number of coughs in a first particular period of time and determine that the animal behavior information indicates a plurality of violent movements of a head of the animal representative of a number of coughs in a second particular period of time and determine that the number of coughs in the first particular period of time is greater than the number of coughs in the second particular period of time.

Aspect 10: The system of Aspects 1 to 9, the at least one processor further to execute the instructions to determine that the animal behavior information indicates a plurality of violent movements of a head of the animal representative of a number of coughs in a first particular period of time and determine that the animal behavior information indicates a plurality of violent movements of a head of the animal representative of a number of coughs in a second particular period of time and determine that the number of coughs in the first particular period of time is less than the number of coughs in the second particular period of time.

Aspect 11: The system of Aspects 1 to 10, the at least one processor further to execute the instructions to train a machine learning model having a dataset with a plurality of images of animals having mastitis.

Aspect 12: The system of Aspects 1 to 11, wherein the dataset comprises images of faces and eyes of healthy cows.

Aspect 13: The system of Aspects 1 to 12, the at least one processor further to execute the instructions to compare the images obtained by the at least one image capture device to the dataset of images of faces and eyes of healthy cows and determine a presence of at least one sunken eye in the animal.

Aspect 14: The system of Aspects 1 to 13, the at least one processor further to execute the instructions to train the machine learning model to detect and analyze eye features of the animal.

Aspect 15: The system of Aspects 1 to 14, the at least one processor further to execute the instructions to determine one of increased visibility of a sclera of the animal, deepening of eye sockets of the animal, and darkening under at least one eye of the animal.

Aspect 16: The system of Aspects 1 to 15, the at least one processor further to execute the instructions to send an image of the animal, the image representative of the potential health condition.

Aspect 17: The system of Aspects 1 to 16, the at least one processor further to execute the instructions to send a video of the animal, the video representative of the potential health condition.

Aspect 18: The system of Aspects 1 to 17, wherein the animal comprises a bovine.

Aspect 19: A method comprising obtaining images, by at least one image capture device, of animal behavior information associated with an animal, comparing, by at least one processor, the animal behavior information with a machine learning model, each machine learning model related to a particular animal health condition, determining, by the at least one processor, that the animal behavior information indicates a potential health condition for the animal, obtaining, by the at least one processor, animal identification information for the animal with the potential health condition, and transmitting, by the at least one processor, a notification indicating the animal identification information for the animal with the potential health condition.

Aspect 20: A non-transitory computer-readable storage medium comprising instructions stored thereon that, when executed by a computing device cause the computing device to perform operations, the operations comprising obtaining images, by at least one image capture device, of animal behavior information associated with an animal, comparing the animal behavior information with a machine learning model, each machine learning model related to a particular animal health condition, determining that the animal behavior information indicates a potential health condition for the animal, obtaining animal identification information for the animal with the potential health condition, and transmitting a notification indicating the animal identification information for the animal with the potential health condition.

What is claimed is:

1. A system comprising:
a memory storing computer-readable instructions; and
at least one processor to execute the instructions to:
obtain images, by at least one image capture device, of animal behavior information associated with an animal;
compare the animal behavior information with a machine learning model, each machine learning model related to a particular animal health condition;
determine that the animal behavior information indicates a potential health condition for the animal;
obtain animal identification information for the animal with the potential health condition; and
transmit a notification indicating the animal identification information for the animal with the potential health condition.

2. The system of claim 1, the at least one processor further to execute the instructions to train a machine learning model having a dataset with a plurality of images of animals having Bovine Respiratory Disease Complex (BRDC).

3. The system of claim 1, the at least one processor further to execute the instructions to detect and track a head of the animal.

4. The system of claim 3, the at least one processor further to execute the instructions to extract relevant features from the images, the relevant features comprising one of head movement patterns, acceleration of the head of the animal, and jerking motions of the head of the animal.

5. The system of claim 4, the at least one processor further to execute the instructions to provide annotation of the images by labeling images where the animal exhibits head jerks associated with one of coughing and breathing issues.

6. The system of claim 5, the at least one processor further to train the model using the annotation.

7. The system of claim 1, the at least one processor further to execute the instructions to determine that the animal behavior information indicates a violent movement of a head of the animal representative of a cough.

8. The system of claim 1, the at least one processor further to execute the instructions to determine that the animal behavior information indicates a plurality of violent movements of a head of the animal representative of a number of coughs in a particular period of time.

9. The system of claim 1, the at least one processor further to execute the instructions to determine that the animal behavior information indicates a plurality of violent movements of a head of the animal representative of a number of coughs in a first particular period of time and determine that the animal behavior information indicates a plurality of violent movements of a head of the animal representative of a number of coughs in a second particular period of time and determine that the number of coughs in the first particular period of time is greater than the number of coughs in the second particular period of time.

10. The system of claim 1, the at least one processor further to execute the instructions to determine that the animal behavior information indicates a plurality of violent movements of a head of the animal representative of a number of coughs in a first particular period of time and determine that the animal behavior information indicates a plurality of violent movements of a head of the animal representative of a number of coughs in a second particular period of time and determine that the number of coughs in the first particular period of time is less than the number of coughs in the second particular period of time.

11. The system of claim 1, the at least one processor further to execute the instructions to train a machine learning model having a dataset with a plurality of images of animals having mastitis.

12. The system of claim 11, wherein the dataset comprises images of faces and eyes of healthy cows.

13. The system of claim 12, the at least one processor further to execute the instructions to compare the images obtained by the at least one image capture device to the dataset of images of faces and eyes of healthy cows and determine a presence of at least one sunken eye in the animal.

14. The system of claim 13, the at least one processor further to execute the instructions to train the machine learning model to detect and analyze eye features of the animal.

15. The system of claim 14, the at least one processor further to execute the instructions to determine one of increased visibility of a sclera of the animal, deepening of eye sockets of the animal, and darkening under at least one eye of the animal.

16. The system of claim 1, the at least one processor further to execute the instructions to send an image of the animal, the image representative of the potential health condition.

17. The system of claim 1, the at least one processor further to execute the instructions to send a video of the animal, the video representative of the potential health condition.

18. The system of claim 1, wherein the animal comprises a bovine.

19. A method, comprising:
obtaining images, by at least one image capture device, of animal behavior information associated with an animal;
comparing, by at least one processor, the animal behavior information with a machine learning model, each machine learning model related to a particular animal health condition;
determining, by the at least one processor, that the animal behavior information indicates a potential health condition for the animal;
obtaining, by the at least one processor, animal identification information for the animal with the potential health condition; and
transmitting, by the at least one processor, a notification indicating the animal identification information for the animal with the potential health condition.

20. A non-transitory computer-readable storage medium comprising instructions stored thereon that, when executed by a computing device cause the computing device to perform operations, the operations comprising:
obtaining images, by at least one image capture device, of animal behavior information associated with an animal;
comparing the animal behavior information with a machine learning model, each machine learning model related to a particular animal health condition;
determining that the animal behavior information indicates a potential health condition for the animal;
obtaining animal identification information for the animal with the potential health condition; and
transmitting a notification indicating the animal identification information for the animal with the potential health condition.
